(19) United States
(12) Patent Application Publication
(10) Pub. No.: US 2019/0203656 A1
(43) Pub. Date: Jul. 4, 2019

(54) METHOD OF CONTROLLING AND MONITORING A FUEL INJECTOR

(71) Applicant: DELPHI AUTOMOTIVE SYSTEMS LUXEMBOURG SA, Bascharage (LU)

(72) Inventor: Francois Ravenda, Longwy (FR)

(21) Appl. No.: 16/311,843

(22) PCT Filed: Jun. 19, 2017
(86) PCT No.: PCT/EP2017/064890

§ 371 Date: Dec. 20, 2018

(30) Foreign Application Priority Data
Jun. 21, 2016 (GB) 1610814.4

(51) Int. Cl. F02D 41/20; F02D 19/02

(52) U.S. Cl. CPC F02D 41/20; F02D 19/024; F02D 2041/2055; F02D 2041/2051; F02D 2041/2027

(57) ABSTRACT

A method of controlling a solenoid actuated fuel injector including applying a activation (pulse) profile to the solenoid, the activation profile including a hold phase, the hold phase including one or more hold pulses, and including a Pulse Width Modulation (PWM) scheme. The method includes determining the time period between the first hold pulse and the end of the previous pulse in the PWM scheme and increasing the energy of the activation profile if the time period is above a threshold.

### CROSS REFERENCE TO RELATED APPLICATIONS

This application is a national stage application under 35 USC 371 of PCT Application No. PCT/EP2017/064890 having an international filing date of Jun. 19, 2017, which is designated in the United States and which claimed the benefit of GB Patent Application No. 1610814.4 filed on Jun. 21, 2016, the entire disclosures of each are hereby incorporated by reference in their entirety.

### FIELD OF THE INVENTION

This disclosure relates to methods of controlling and monitoring and ensuring correct actuation of fuel injectors. It thus relates to a method of ensuring correct opening of a solenoid actuated fuel injector, so as to reduce incorrect opening and maintaining correctly a fuel injector valve (e.g. pintle) in an open position during an open phase. It has particular but not exclusive application to reducing non-opening of solenoid operated fuel injector valves and subsequent control.

### BACKGROUND

Solenoid or piezo electric actuated fuel injectors typically are controlled by pulses sent to the actuator of a fuel injector, so as to open a fuel injector valve and allow fuel to be dispensed. Such actuators act to displace (via the armature of the actuator) a pintle and needle arrangement of the valve to move the needle away from a valve seat. In such a state the valve is open to allow fuel to be dispensed and when the pulse falls there is no power to the actuator and the valve is forced to a closed position.

Pulse (actuation) profiles may vary and may comprise a series of pulses or phases used to operate the solenoid. There may be an initial (relatively high) activation pulse, provided in order initiate the actuator so as provide the force required to move the needle away from the valve seat, thereafter the pulse and thus power to the actuator is reduced. After a short while this may be followed by a “hold phase” where a reduced level of power is applied to keep the valve in the open position. The hold phase and other phases are typically controlled by a series of pulses whose frequency and duration is varied—commonly referred to as pulse width modulation (PWM). These pulses may be regarded as fueling pulses. Thereafter the pulse and this voltage is reduced to close the valve.

Opening speed control strategy has been developed to limit axial stresses present in direct injection (DI) CNG injectors, via control of armature landing speed, by varying and setting drive scheme parameters, typically manifested as PWM pulses applied to open and hold the injector open. This may be followed by one or more braking pulses which act to slow the movement of pintle and needle when closing.

A problem with solenoid operated valves for fuel injectors (in particular gaseous fuel injectors) is sub-components (moving parts) sticking after a soak period due to oil residues or icing of CNG water content that will results in injector not opening failure. These phenomenon are well known and described within automotive industry and generally addressed via hardware solutions. Opening speed control has to ability to recover from those particular situations however it may requires a long learning sequence that would not be acceptable. The unpredictability and sudden nature of the failure mode (e.g. due to non-opening) require additional criteria and specific algorithms to ensure fast recovery of optimal injector performance via similar type of drive scheme parameters modulation used in main algorithms.

It is an object of the invention to overcome these problems. Aspects provide a way to detect failure mode (non or partial needle opening) and also provide control to overcome this problem by adaptive control. Aspects allow recovery form such problems within a few pulses.

### STATEMENT OF THE INVENTION

In one aspect is provided A method of controlling a solenoid actuated fuel injector comprising applying a activation (pulse) profile to said actuator, said activation profile including a hold phase, said hold phase including one or more hold pulses, and including a Pulse Width Modulation (PWM) scheme, comprising;

a) determining the time period between the first hold pulse and the end of the previous pulse in the PWM scheme;

b) increasing the energy of said activation profile if said time period is above a threshold.

Step a) may be performed in an opening phase.

Said injector may a direct gas injector

Step a) may comprise monitoring when the voltage level after said end of said previous pulse falls below a certain value.

Step b) may comprise increasing the voltage and or current of one of more initial pulses of said activation profile.

### BRIEF DESCRIPTION OF DRAWINGS

The invention will now be described by way of example and with reference to the following figures of which:

FIGS. 1 and 2 show plots of the voltage applied to the solenoid injector actuator solenoid, the solenoid current 1, and as well as the pintle displacement for respectively valves which operate normally and do not open correctly;

FIGS. 3 and 4 show plots similar to FIGS. 1 and 2;

FIG. 5 shows a set of results showing for various injectors; and,

FIG. 6 shows a flow chart of the method according to one example.

### DETAILED DESCRIPTION OF THE INVENTION

In order to activate a solenoid operated fuel injector, typically a pulse width modulator is used to generate pulses sent to the solenoid in order to operate the injector. The control of pulse width modulation is effected in order to e.g. maintain particular values of current during particular phases of the injection cycle. Typically a pulse width modulator is used to maintain an initial relatively high current for a set period of time in order to open the valve.

Particularity of CNG injector solenoid coil is a significant higher stroke than gasoline counterpart, with coil inductance being significantly different from closed to open position. A pulse with modulated voltage control is used to obtain and maintain current level (energy) desired within different phases of a pulse drive profile following basic equation: V=R*I+L*(Di/Dt). The inventor have made use of this observation to provide a method to detect robustly an injector not open by monitoring PWM frequency e.g. within a dedicated phase (the hold phase).

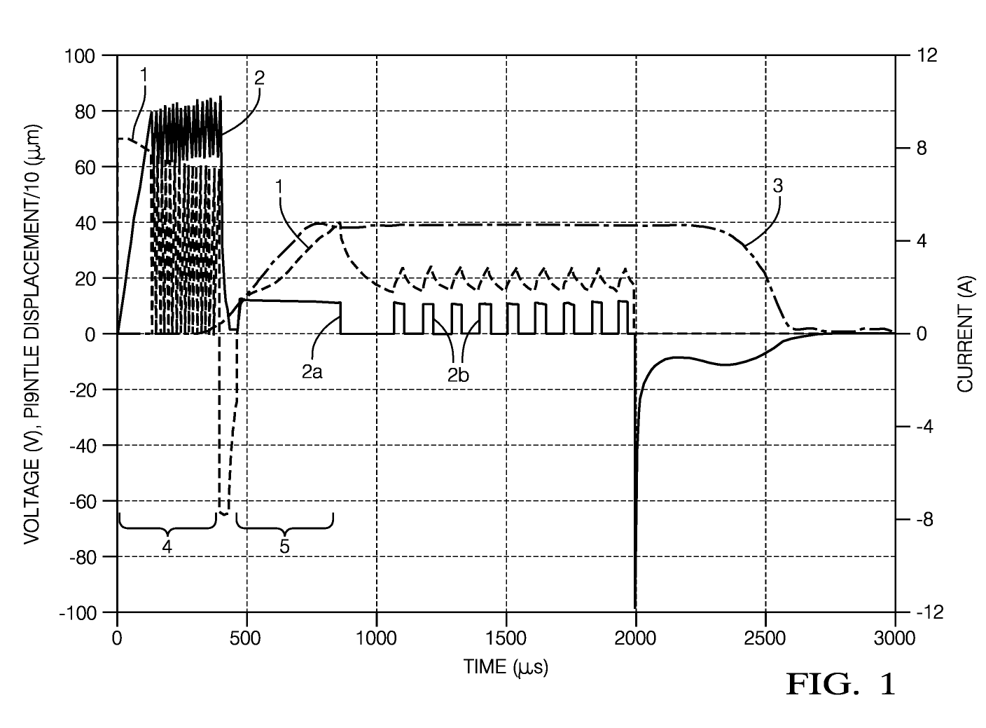

FIG. 1 shows a plot of the voltage 2 applied to the solenoid injector actuator solenoid, the solenoid current 1, and as well as the pintle displacement 3 of a normally operating solenoid controlled valve in the opening phase. The voltage/current can be regarded as an activation profile and may include a Pulse Width Modulation Scheme. The applied voltage (activation) profile is controlled so as to achieve the desired current to open and hold the valve in the open position. At the start, a high voltage is applied to the solenoid in order to achieve a relatively high current through the solenoid to open the valve. As can be seen a current of about 8A is required, and a high voltage is initially applied to produce this current. These high values are required to overcome initial high friction and other forces as well as to impart momentum to the valve components. During this initial period (opening phase) 4, the pintle starts to move. There is typically a chopping of the voltage to control the current along a plateau.

After this a negative voltage may be applied and then a pulse 2a along time period 5 is applied in order to provide a lower opening current and thus force. During this time the pintle moves at a higher rate to its fully open position. After the initial pulse, further “hold” pulses 2b are applied, so as e.g. to maintain the valve in the open position. Control is provided by appropriate PWM control/chopping e.g. to maintain the current at around 3A. This is achieved by standard pulse width modulation control. The start of the chopping is controlled dependent on the current falling to a particular level. This is achieved in some cases by current measuring means or is performed inherently e.g. the current is effectively sensed by standard chopping and PWM control methods.

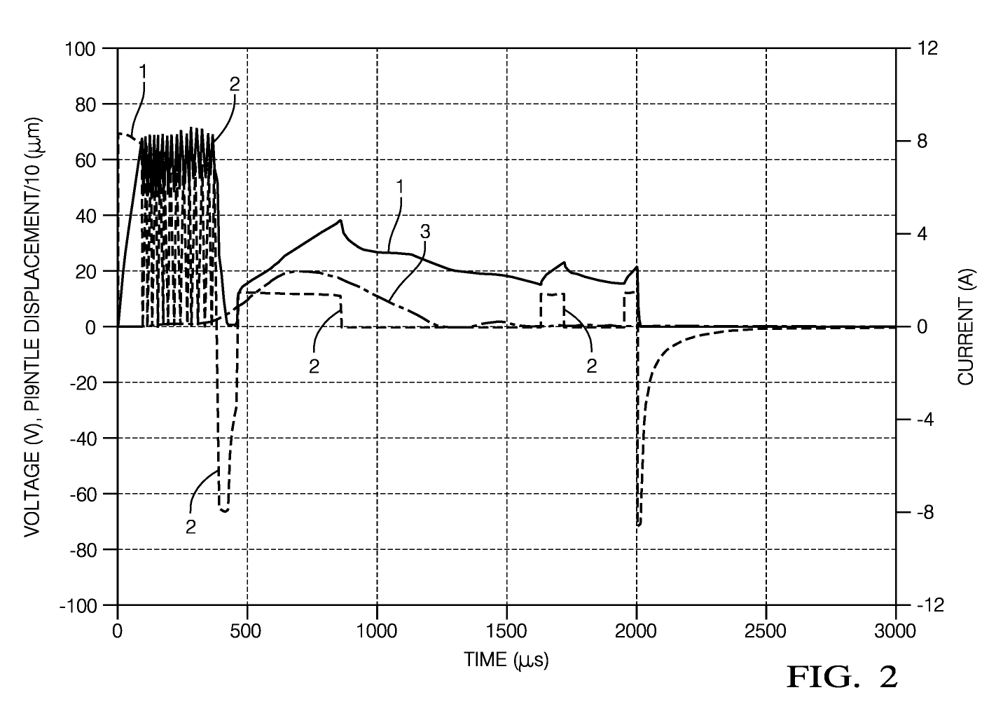

FIG. 2 shows a similar plots for a solenoid valve which does not open or does not open properly. A can be seen after the initial pulse the current only falls at a lower rate, and for this reason the system and inherent PWM methodology does not apply the next pulse in the chopping phase until a lot later.

The inventors have made use of this observation to provide indication of a non-opening/incorrectly opening valve and thus to provide a method to detect robustly an injector not open by monitoring PWM frequency e.g. within a dedicated phase (the hold phase).

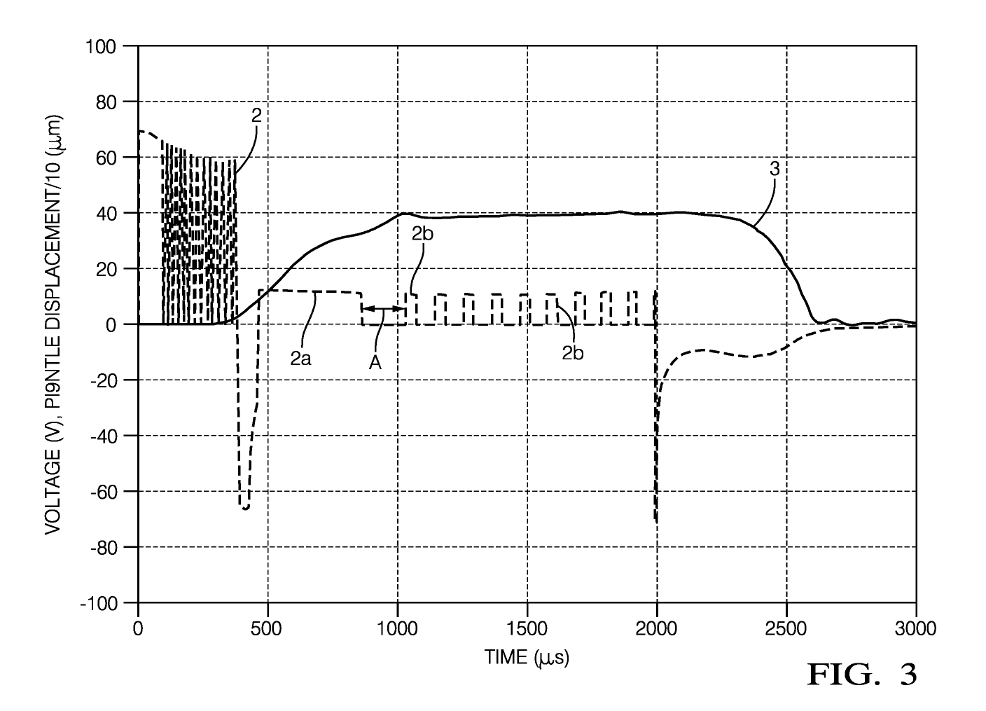

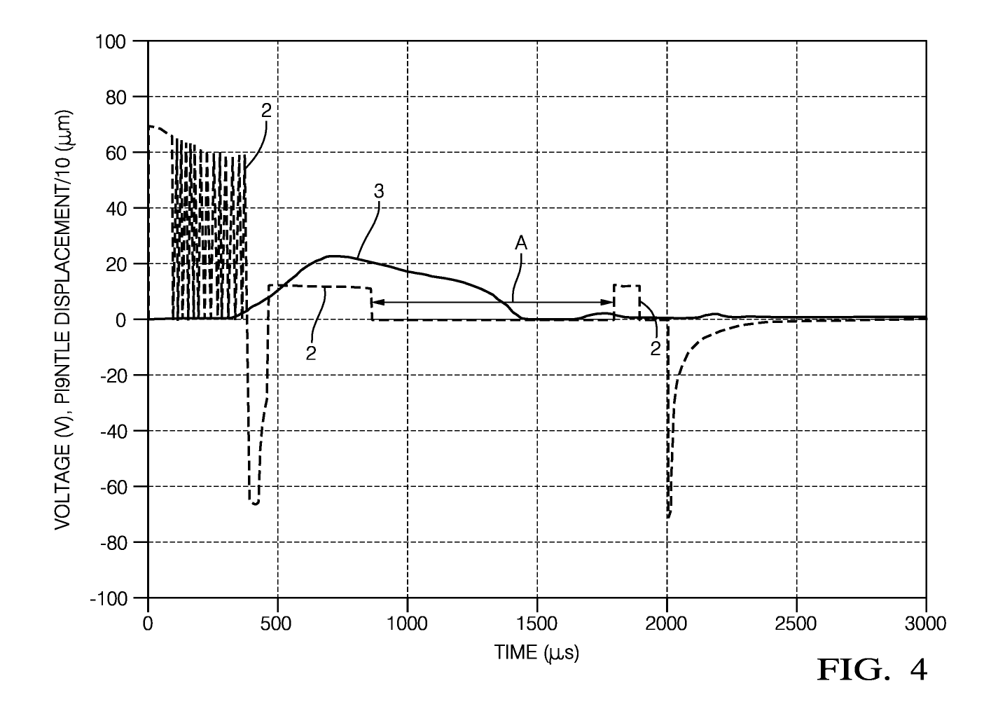

FIGS. 3 and 4 show plots similar to FIGS. 1 and 2. FIG. 3 is similar to FIG. 1 where the valve opens normally and FIG. 4 is similar to FIG. 3 where the valve does not open. As can be seen the time period between the end of the PWM pulse 2a which precedes up to the next pulse (e.g. first hold pulse) as shown by the arrow A is much larger for the case where the valve does not open.

Effectively determining the time period of arrow A is equivalent to evaluate the time that time voltage is equal to 0 or below a predefined value. It is to be noted that once the valve is open, the effective inductance of the solenoid changes and thus the current changes differently with voltage. Once the injector is open the current decays. There is a significant change in inductance when the injector is open. The PWM works to set the current thus when it decays below a certain level.

In embodiments this time period is determined and used to detect whether a valve is opening properly or not; if not, adaptive control is applied as a result of this determination so the problem is overcome. If it is detected the valve is not opening or not opening properly appropriate control may be provided such as increasing in the energy of the overall activation pulse profile. The pulses of the profile may e.g. be set with higher voltages.

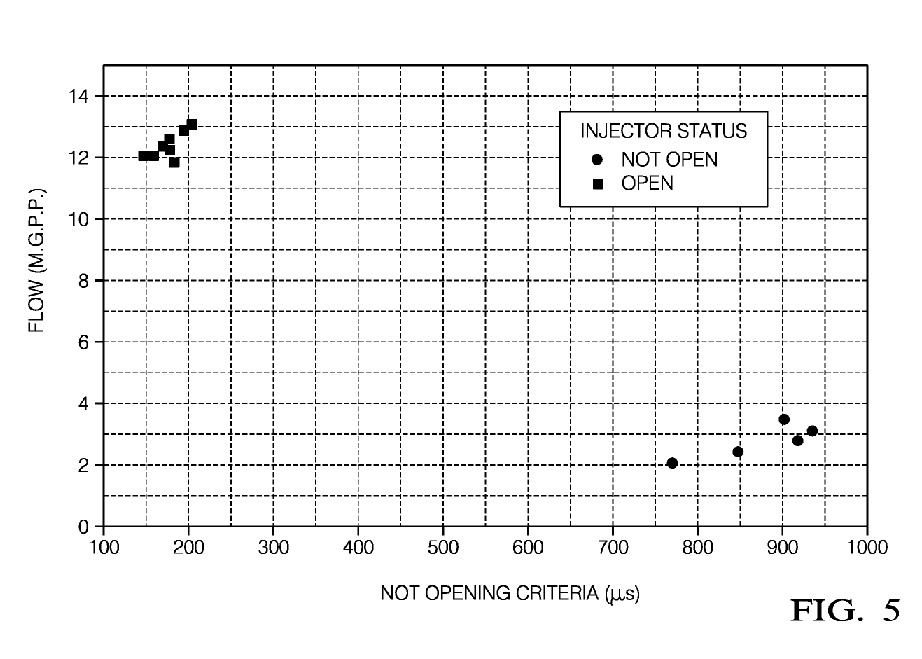

FIG. 5 shows a set of results showing for various injectors some of which failed to open normally; specifically the criteria above were recorded; the time period depicted by arrow A against fuel flow. As can be seen there is a clear clustering and so the method shows that the opening/non-opening criterion are distinct and thus the methodology is highly robust.

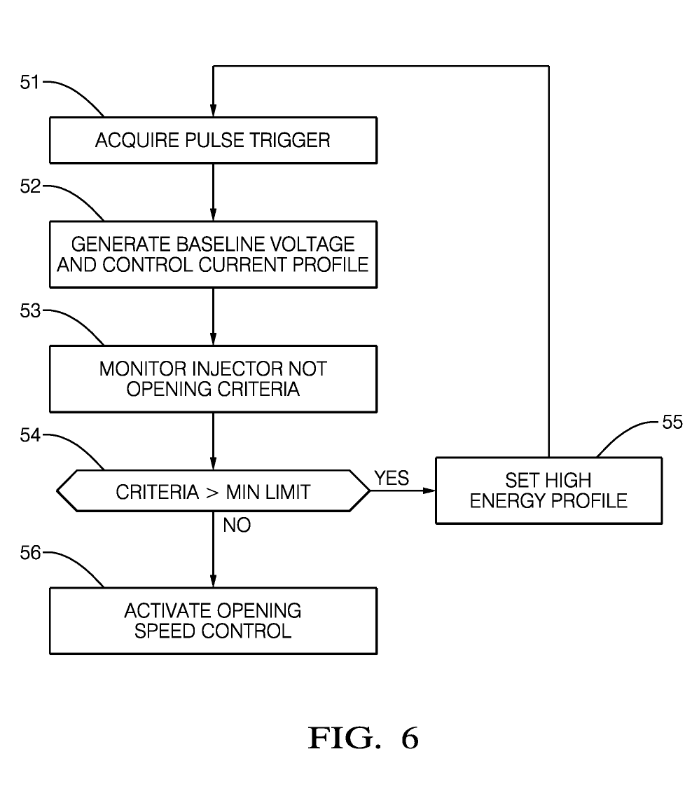

FIG. 6 shows a flow chart of the method according to one example. Here initially a pulse trigger is acquired/received at step 51—this trigger initiates activation of the fuel injector by applying a set pulse profile thereto. At step 52 a baseline voltage (and current) profile is generated according to set profile. In the next step, 53, the injector “not-opening” criterion described above is monitored i.e. the length of the time period A. At step 54 the length of period A is checked with a thresholf. In step 55, if the criterion, i.e. the length of the period A is above a threshold limit, then a non-opening event is determined. For the subsequent control via applied pulse (voltage) profile, this is set with a higher a higher energy profile. This overcomes e.g. sticking problems which predominantly cause the valve to stick. The procedure then returns to step S1. If not at step 56 the opening speed control is activated with the existing profile.

1-5. (canceled)

6. A method of controlling a solenoid actuated fuel injector comprising applying an activation profile to said solenoid, said activation profile including a hold phase, said hold phase including one or more hold pulses, and including a Pulse Width Modulation (PWM) scheme, said method comprising;
a) determining a time period between the first hold pulse and the end of a previous pulse in the PWM scheme;
b) increasing the energy of said activation profile for one or more subsequent activations if said time period is above a threshold.

7. A method as claimed in claim 6, wherein step a) is performed in an opening phase.

8. A method as claimed in claim 6, wherein said fuel injector is a direct gas injector.

9. A method as claimed in claim 6, where step a) comprises monitoring when a voltage level after said end of said previous pulse falls below a certain value.

10. A method as claimed in claim 6, where step b) comprises increasing a voltage and/or a current of said one of more initial pulses of said activation profile.
